(19) United States
(12) Patent Application Publication
(10) Pub. No.: US 2023/0252647 A1
(43) Pub. Date: Aug. 10, 2023

(54) TRACKING DEVICE, TRACKING SYSTEM, TRACKING METHOD, AND TRACKING PROGRAM

(71) Applicant: Nippon Telegraph and Telephone Corporation, Tokyo (JP)

(72) Inventors: Hikotoshi NAKAZATO, Musashino-shi, Tokyo (JP); Kenji ABE, Musashino-shi, Tokyo (JP)

(21) Appl. No.: 18/012,813

(22) PCT Filed: Jun. 25, 2020
(86) PCT No.: PCT/JP2020/025078

§ 371 Date: Dec. 23, 2022

(51) Int. Cl. G06T 7/20; G06V 10/44; G06V 20/52

(52) U.S. Cl. CPC G06T 7/20; G06V 10/44; G06V 20/52

(57) ABSTRACT

A tracking device includes a recognition model storage unit, which stores a recognition model containing one or more feature quantities of a tracking target on a tracking target basis, a candidate detection unit, which extracts the tracking target from images captured by a monitoring camera associated with the tracking device by using the recognition model, a model creation unit, which updates the recognition model in the recognition model storage unit by adding a new feature quantity detected from the extracted tracking target to the recognition model used by the candidate detection unit to extract the tracking target, and a communication unit, which distributes the recognition model updated by the tracking device to another device that performs monitoring based on another monitoring camera located within a predetermined range from the monitoring camera associated with the tracking device.

### TECHNICAL FIELD

The present invention relates to a tracking device, a tracking system, a tracking method, and a tracking program.

### BACKGROUND ART

With the widespread use of web cameras as one of the IoT (Internet of Things) devices, there are proposed systems that mechanically extract useful information from images captured by web cameras.

Non-Patent Literature 1 describes that a feature vector formed of the color, shape, and texture of a butterfly image is applied to a self-organizing map (SOM) to sort butterfly species.

Non-Patent Literature 2 describes that convolutional neural network (CNN) is combined with SOM to learn images showing human emotional expressions and reflect the emotional expressions in a robot.

### CITATION LIST

### Non-Patent Literature

Non-Patent Literature 1: Takashi HYUGA, Ikuko NISHIKAWA, “Implementing the Database System of Butterfly Specimen Image by Self-Organizing Maps”, Journal of Japan Society for Fuzzy Theory and Systems, Vol. 14, No. 1, pp. 74-81, 2002, [online], [retrieved on Jun. 12, 2020], Internet <URL:https://www.jstage.jst.go.jp/article/jfuzzy/14/1/14_KJ00002088995/_pdf/-char/ja>

Non-Patent Literature 2: Nikhil Churamani et al., “Teaching Emotion Expressions to a Human Companion Robot using Deep Neural Architectures”, DOI: 10.1109/IJCNN.2017.7965911 Conference: 2017 International Joint Conference on Neural Networks (IJCNN), At Anchorage, Ak., USA, [online], [retrieved on Jun. 12, 2020], Internet <URL:https://www.researchgate.net/publication/318191605_Teaching_Emotion_Expressions_to_a_Human_Companion_Robot_using_Deep_Neural_Architectures>

### SUMMARY OF THE INVENTION

### Technical Problem

A crime prevention system will be studied below. The crime prevention system detects a moving target having taken a specific action, such as a person carrying a knife, as a tracking target from images captured by web cameras installed at a variety of locations in a city, and continuously catches the person's travel trajectory by using the cameras.

In conventional tracking systems, to track a moving target from captured images, a recognition model of the tracking target needs to be learned in advance. Therefore, moving targets for which no prior learning has been performed, such as non-planned robbers, cannot be tracked.

In view of the circumferences described above, a primary object of the present invention is to track a moving target having undergone no prior learning.

### Means for Solving the Problem

To achieve the object described above, a tracking system according to the present invention has the following features:

A tracking device according to the present invention includes a recognition model storage unit that stores a recognition model containing one or more feature quantities of a tracking target on a tracking target basis,

a candidate detection unit that extracts the tracking target from images captured by a monitoring camera associated with the tracking device by using the recognition model,

a model creation unit that updates the recognition model in the recognition model storage unit by adding a new feature quantity detected from the extracted tracking target to the recognition model used by the candidate detection unit to extract the tracking target, and

a communication unit that distributes the recognition model updated by the tracking device to another device that performs monitoring based on another monitoring camera located within a predetermined range from the monitoring camera associated with the tracking device.

### Effects of the Invention

According to the present invention, a moving target having undergone no prior learning can be tracked.

### BRIEF DESCRIPTION OF DRAWINGS

FIG. 1 is a descriptive diagram showing tracking target images according to an embodiment of the present invention and feature quantities extracted from the images.

FIG. 2 is a descriptive diagram of a CNN used to extract the feature quantities in FIG. 1 according to the embodiment.

FIG. 3 is a descriptive diagram expressing the result of the extraction of the feature quantities in FIG. 1 in the form of an SOM according to the embodiment.

FIG. 4 shows the configuration of a moving target tracking system according to the embodiment.

FIG. 5 is a table showing the process in which the moving target tracking system tracks a person based on the tracking target images in FIG. 1 according to the embodiment.

FIG. 6 is a table showing processes subsequent to those in FIG. 5 according to the embodiment after an observer specifies a suspect from the tracking target images.

FIG. 7 is a descriptive diagram showing derived models of a person Pc1 in the SOM in FIG. 3 according to the embodiment.

FIG. 8 is a table showing a labor saving process achieved by eliminating monitoring performed by the moving target tracking system according to the embodiment.

FIG. 9 shows the hardware configuration of a tracking device according to the embodiment.

### DESCRIPTION OF EMBODIMENTS

An embodiment according to the present invention will be described below in detail with reference to the drawings.

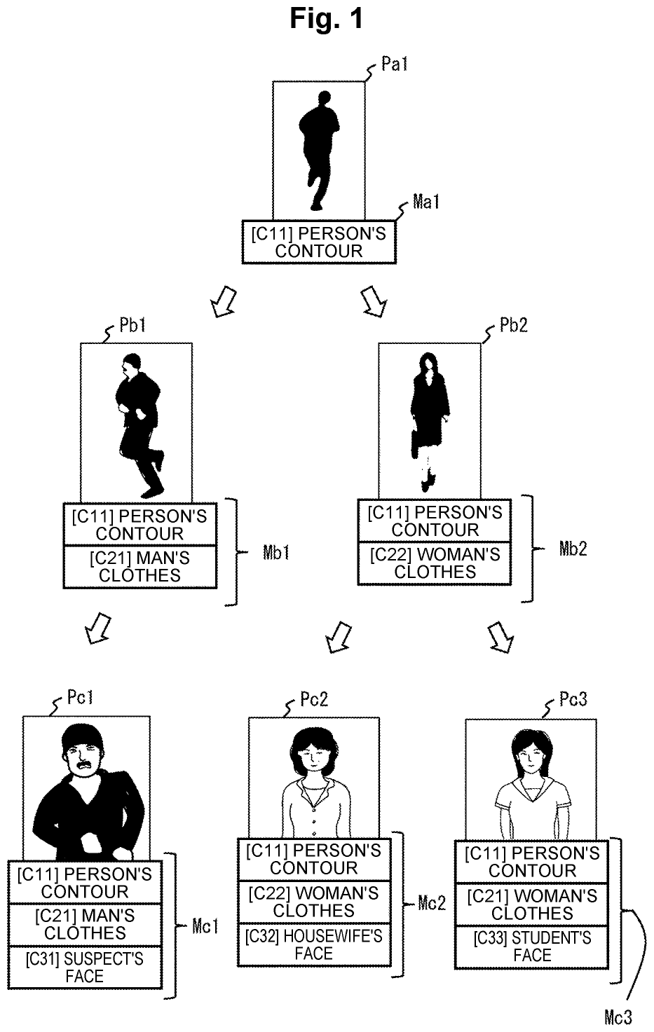

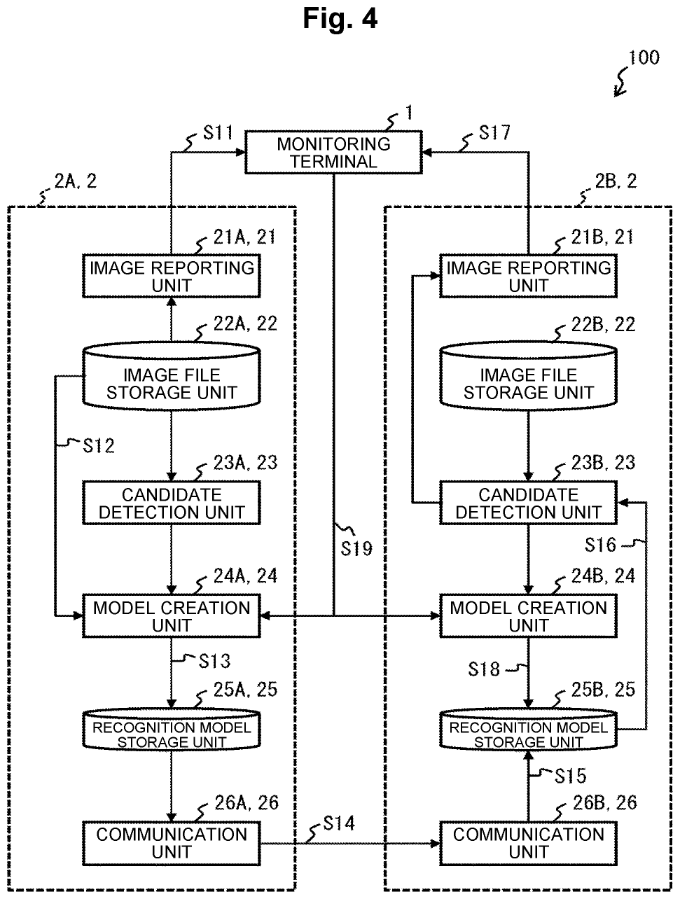

First, as an introduction, a tracking process carried out by a moving target tracking system 100 shown in FIG. 4 will be described with reference to FIGS. 1 to 3. FIG. 4 and the following figures clarify the configuration of the present invention.

FIG. 1 is a descriptive diagram showing images containing tracking targets and feature quantities extracted from the images. In the present embodiment, a robbery suspect is presented as an example of the tracking target. On the other hand, the tracking target handled by the moving target tracking system 100 is not limited to persons, and the moving target tracking system 100 may handle animals such as pets, vehicles, and other objects. It is assumed that the robbery suspect found at a point A escapes via a point B to a point C.

A tracking device 2 (FIG. 4) responsible for the point A detected a moving target (suspect) corresponding to one person from a camera that monitors the point A, as shown in the upper portion of FIG. 1. Specifically, an image recognition application at the point A detected a dangerous action, such as a person holding a knife, in the video images from the camera and cut off an image area containing the person as a tracking target image Pa1.

The tracking target image Pa1 detected by the monitoring camera at the point A is associated with a recognition model Ma1, which is instantly formed from the tracking target image Pa1. The recognition model Ma1 contains a [person's contour C11] as the feature quantity extracted from the tracking target image Pa1. When the moving object was initially found at the point A, a variety of features of the target cannot be immediately detected from the video images due to a variety of constraints such as the arrangement of the monitoring camera and the position of the target.

The recognition model Ma1 created at the point A propagates from the point A to the point B therearound so that the tracking continues (illustrated as two arrows originating from recognition model Ma1).

The tracking device 2 responsible for the point B detected moving targets that corresponded to two persons and agreed with the feature quantity of the propagated recognition model Ma1 from the video images from the camera that monitored the point B, as shown in a central portion of FIG. 1.

As a first person, a tracking target image Pb1 is associated with a recognition model Mb1 extracted from the tracking target image Pb1. In addition to the [person's contour C11] contained in the recognition model Ma1, with which the first person agrees, the recognition model Mb1 contains a feature quantity [man's clothes C21] newly extracted from the tracking target image Pb1.

As a second person, a tracking target image Pb2 is associated with a recognition model Mb2 extracted from the tracking target image Pb2. In addition to the [person's contour C11] contained in the recognition model Ma1, with which the second person agrees, the recognition model Mb2 contains a feature quantity [woman's clothes C22] newly extracted from the tracking target image Pb2.

The recognition models Mb1 and Mb2 created at the point B propagate from the point B to the point C therearound so that the tracking continues (illustrated as three arrows in total originating from recognition models Mb1 and Mb2).

The tracking device 2 responsible for the point C detected, from the camera that monitored the point C, a moving target that corresponded to one person that agreed with the feature quantities contained in the propagated recognition model Mb1 and a moving target that corresponded to two persons that agreed with the feature quantities contained in the propagated recognition model Mb2 (that is, moving targets corresponding to three persons in total), as shown in the lower portion of FIG. 1.

As a first person, a tracking target image Pc1 is associated with a recognition model Mc1 extracted from the tracking target image Pc1. In addition to the [person's contour C11] and the [man's clothes C21] of the recognition model Mb1, with which the first person agrees, the recognition model Mc1 contains a feature quantity [suspect's face C31] newly extracted from the tracking target image Pc1.

As a second person, a tracking target image Pc2 is associated with a recognition model Mc2 extracted from the tracking target image Pc2. In addition to the [person's contour C11] and the [woman's clothes C22] contained in the recognition model Mb2, with which the second person agrees, the recognition model Mc2 contains a feature quantity [housewife's face C32] newly extracted from the tracking target image Pc2.

As a third person, a tracking target image Pc3 is associated with a recognition model Mc3 extracted from the tracking target image Pc3. In addition to the [person's contour C11] and the [woman's clothes C22] contained in the recognition model Mb2, with which the third person agrees, the recognition model Mc3 contains a feature quantity [student's face C33] newly extracted from the tracking target image Pc3.

As described above, as the catching period increases along the path from the point A via the point B to the point C, acquirable feature quantities are also successively added to the recognition models. Reflecting the feature quantities acquired from the video images in the course of tracking to the recognition models in subsequent courses as described above allows narrowing-down of tracking target candidates from a large number of persons contained in the video images from the monitoring cameras. FIG. 1 shows an example in which the number of recognition models increases in the following order.

(Point A) Contour of the background only

(Point B) The features of the clothes a person was wearing were found.

(Point C) Detailed facial features were also found.

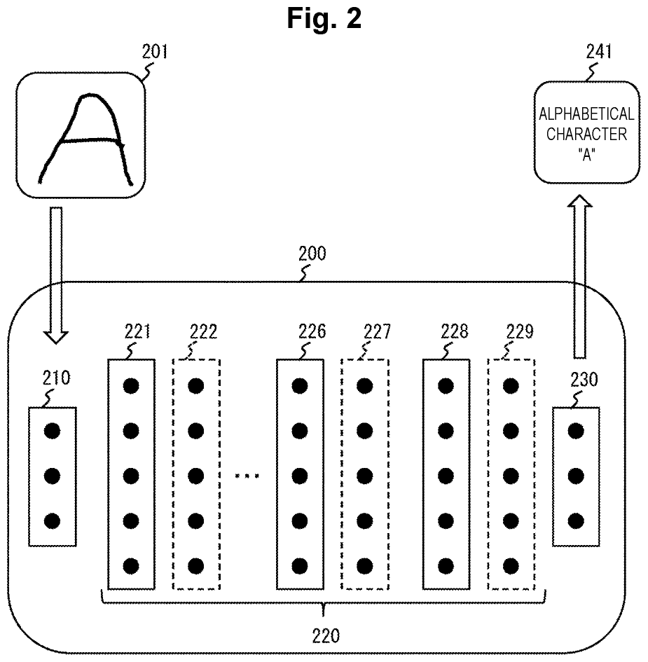

FIG. 2 describes a CNN used to extract the feature quantities in FIG. 1.

A CNN 200 is formed of an input layer 210, which accepts an input image 201, a hidden layer 220, and an output layer 230, which outputs a result of determination of the input image 201, with the three layers connected to each other.

The hidden layer 220 is formed of alternately repeated layers, a convolutional layer 221→a pooling layer 222→ . . . →a convolutional layer 226→a pooling layer 227. The convolutional layers each perform convolution (image abstraction), and the pooling layers each perform pooling to provide the positional movement of an image with universality.

The pooling layer 227 is then connected to full connection layers 228 and 229. Immediately before the full connection layers (boundary between pooling layer 227 and full connection layer 228), there is a final feature quantity map containing a variety of features such as the color and shape of the image, and the variety of features can be used as the feature quantities contained in the recognition models extracted in FIG. 1.

That is, the tracking target image Pa1 in FIG. 1 can, for example, be used as the input image 201, and feature quantities can be determined from the final feature quantity map (high-dimensional vector) propagated from the input image 201 and immediately before the full connection layers of the CNN 200.

The CNN shown in FIG. 2 is merely one means for extracting feature quantities, and other means may be used. For example, a CNN is not necessarily used, and another means capable of converting a variety of features of an image of a tracking target object, such as the color and shape, into a feature quantity vector containing the features may be used to extract feature quantities. An administrator of the tracking device 2 may instead use an algorithm capable of separately extracting features of a person, such as the contour, clothes, and glasses, to explicitly extract individual feature quantities as the feature quantities to be added to the recognition models.

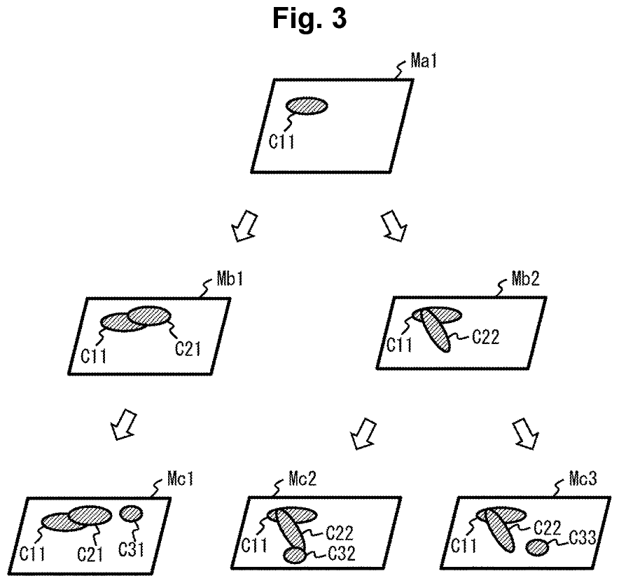

FIG. 3 is a descriptive diagram expressing the result of the extraction of the feature quantities in FIG. 1 in the form of an SOM. The arrows shown in FIG. 3, such as the recognition model Ma1→the recognition model Mb1, represent a path along which the recognition model is distributed, as in FIG. 1. The path information is written to each recognition model and therefore allows clarification of the source from which a recognition model is distributed (derived).

An SOM is a data structure that maps a high-dimensional observed data set to a two-dimensional space while preserving the topological structure of the data distribution, and is used in unsupervised learning algorithms. Persons adjacent to each other in the SOM have data vectors that are close to each other also in an observation space.

For example, the recognition model Mb1 contains the [person's contour C11] and the [man's clothes C21] adjacent to each other in the SOM. This means that the [man's clothes C21] has been newly detected from the tracking target having the feature quantity [person's contour C11].

In the SOM, data can be classified based on the positional relationship in an inter-input-vector two-dimensional map. Therefore, repeated propagation and learning of the weight of each input information on a dimension basis allows learning in which a sample distribution in the input space is mapped.

The process of adding a feature quantity to each SOM (recognition model) is described in detail, for example, in a reference “Kohonen Network as a New Modeling Tool,” [retrieved on Jun. 12, 2020], Internet <URL: https://cicsj.chemistry.or.jp/15_6/funa.html>.

To create the SOM shown in FIG. 3 based on the reference described above, a “U-matrix method” may be used to deduce an area within a fixed range from a vector based on a “winner neuron” provided from a mapped feature quantity, and the deduced existence area (feature quantity) on a tracking target SOM map may be added to a recognition model.

The “winner neuron” is a neuron having a weight vector most similar to a reference vector (one input vector). The weight vector of a winner neuron c and weight vectors in the vicinity of the winner neuron c are modified so as to approach the input vector.

The “U-matrix method” is an approach that allows visual checking of the similarity/dissimilarity between units of adjacent output layer neurons based on distance information between the adjacent units. The space between neurons having a small similarity (far in distance) is expressed as a “mountain”.

FIG. 4 shows the configuration of the moving target tracking system 100.

The moving target tracking system 100 is formed of a monitoring terminal 1, which is used by an observer in a monitoring center, and tracking devices 2 (tracking device 2A at point A and tracking device 2B at point B) deployed at monitoring points, such as those in a city, with the monitoring terminal 1 connected to the tracking devices 2 via a network.

Two tracking devices 2 are shown by way of example in FIG. 4, and one or more tracking devices 2 may be used. One tracking device 2 may be responsible for one point, or one tracking device 2 may be responsible for a plurality of points.

The tracking devices 2 each include an image reporting unit 21, an image file storage unit 22, a candidate detection unit 23, a model creation unit 24, a storage unit that stores recognition model storage unit 25, and a communication unit 26.

The tracking device 2A at the point A includes an image reporting unit 21A, an image file storage unit 22A, a candidate detection unit 23A, a model creation unit 24A, a recognition model storage unit 25A, and a communication unit 26A (reference character ends with “A”).

The tracking device 2B at the point B includes an image reporting unit 21B, an image file storage unit 22B, a candidate detection unit 23B, a model creation unit 24B, a recognition model storage unit 25B, and a communication unit 26B (reference character ends with “B”).

The components of each of the tracking devices 2 will each be described below with reference to steps (S11 to S19) described in FIG. 4. The steps and arrows shown in FIG. 4 only illustrate part of the relationships between the components of the tracking device 2, and messages are issued as appropriate between the other components that are not shown in FIG. 4.

The image file storage unit 22A stores video images captured by a monitoring camera that is not shown in FIG. 4. The image reporting unit 21A keeps reading video images of suspect candidates (tracking targets) found based, for example, on detection of a dangerous action from the image file storage unit 22A and transmitting the read video images to the monitoring terminal 1 (S11). That is, time-series information on the images of the tracking target candidates detected at each point and a recognition model used in the detection are gathered at the monitoring center moment by moment.

The model creation unit 24A performs image analysis on tracking target images extracted by the candidate detection unit 23A from the video images in the image file storage unit 22A (S12), and creates a recognition model (recognition model Ma1 in FIG. 3, for example,) as a result of the image analysis. The recognition model Ma1 is stored in the recognition model storage unit 25A (S13).

The model creation unit 24A may create a recognition model by combining the CNN in FIG. 2 and the SOM in FIG. 3 with each other, but not necessarily, and may create a recognition model in other ways. For example, the model creation unit 24A may place a feature quantity extracted by the CNN in FIG. 2 in a data structure other than the SOM, or may place a feature quantity extracted by a method other than the CNN in FIG. 2 in the SOM data structure.

The communication unit 26A distributes the recognition model Ma1 created by the model creation unit 24A to the communication unit 26B at the adjacent point B (S14). The distribution destination is not limited to an adjacent point. For example, the distribution destination may be a tracking device 2 responsible for a point within a certain distance (within a radius of 5 km, for example,) from the target detection point of time.

The communication unit 26B reflects the recognition model Ma1 distributed from the point A in S14 in the recognition model storage unit 25B associated with the tracking device 2B (S15) and notifies the candidate detection unit 23B of the recognition model Ma1 (S16).

The candidate detection unit 23B monitors the video images in the image file storage unit 22B at the point B based on the recognition model Ma1, and detects two persons who agree with the recognition model Ma1 as tracking target candidates. The image reporting unit 21B then notifies the monitoring terminal 1 of the originally detected recognition model Ma1 and the tracking target images containing the two newly detected persons (S17). The observer can thus grasp the latest tracking status at the current point of time.

The model creation unit 24B creates the two persons' recognition models Mb1 and Mb2 (that is, updates Ma1), which are notified by the candidate detection unit 23B and which are the result of addition of the new feature quantities to the originally detected recognition model Ma1. The updated recognition models Mb1 and Mb2 are stored in the recognition model storage unit 25B associated with the tracking device 2B (S18) and distributed to other points via the communication unit 26B.

When the updated recognition models Mb1 and Mb2 are propagated back to the point A in the direction opposite the direction indicated by the arrow S14 (current distribution destination=previous distribution source), the recognition model Ma1 in the recognition model storage unit 25A is replaced with the updated recognition models Mb1 and Mb2. In other words, the feature quantity of the old recognition model Ma1 is succeeded by the feature quantities contained in the new recognition models Mb1 and Mb2.

The overall number of recognition models therefore does not increase in proportion to the number of recognition models held by the recognition model storage unit 25 at each point, whereby the period required for the detection can be shortened.

At this point of time, the observer inputs a correct choice trigger to the monitoring terminal 1 when the observer can visually determine the suspect based on the suspect candidate video images notified in S17. Since the number of tracking target candidates explosively increases as the distance from the detection point increases, it is desirable for the observer to input a correct choice flag as early as possible.

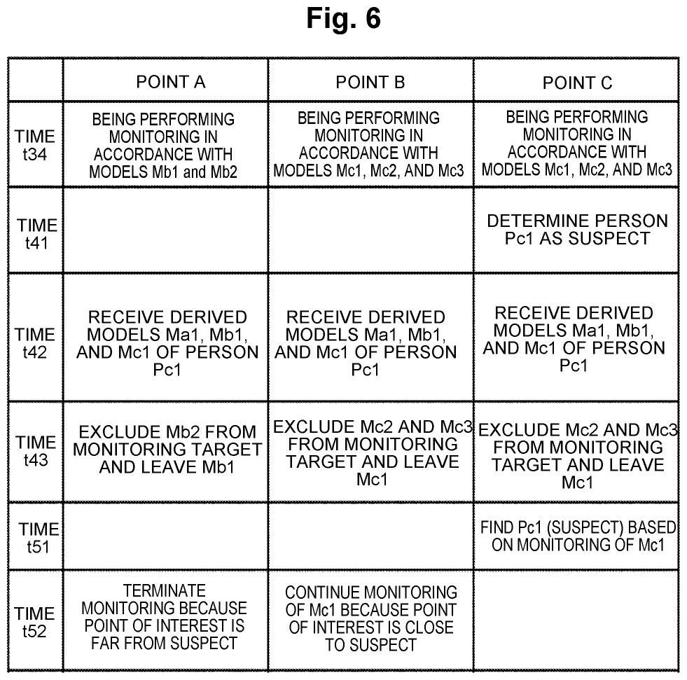

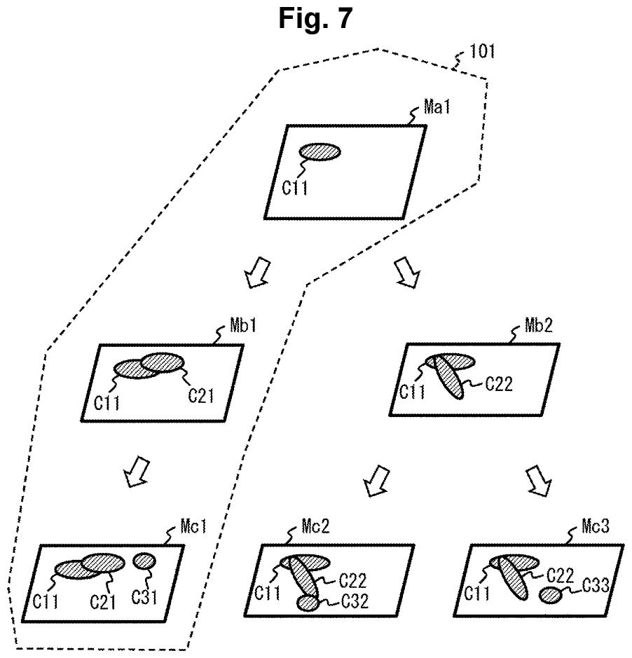

The monitoring terminal 1 notifies the model creation units 24 of the recognition model of the suspect inputted in the form of the correct choice trigger to cause the recognition model storage units 25 to delete the recognition models other than those of the suspect, resulting in reduction in the load of the monitoring process (S19, described later in detail in FIGS. 6 and 7).

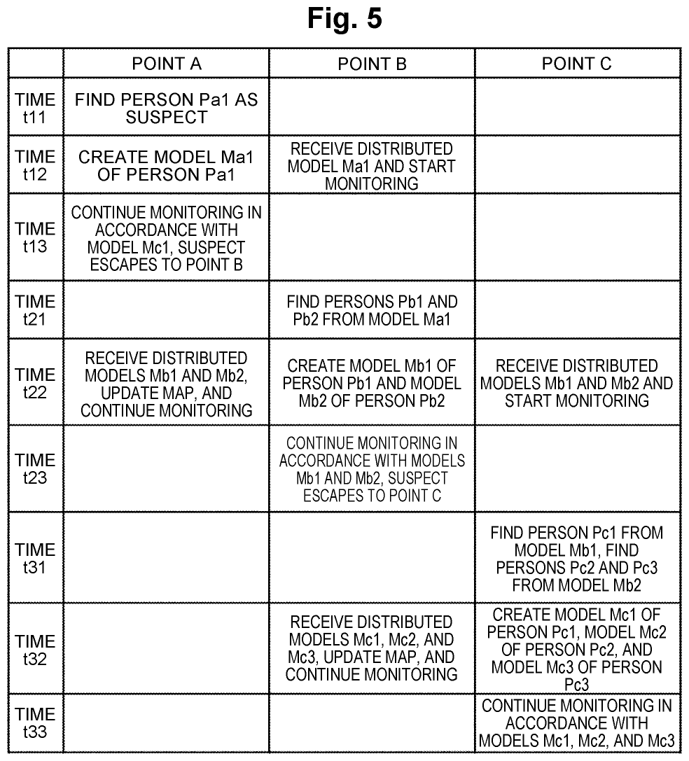

FIG. 5 is a table showing the process in which the moving target tracking system 100 tracks a person based on the tracking target images in FIG. 1. The columns of the table show the points A to C for which the tracking devices 2 are responsible, and the points A and C are located in the vicinity of the point B but are not close to each other. The rows of the table show the time that elapses from the top to the bottom of the table.

The tracking device 2 at the point A finds the tracking target image Pa1 (hereinafter referred to as “person Pa1”) containing the suspect (time t11), and creates the recognition model Ma1 of the person (time t12).

The tracking device 2 at the point B receives the recognition model Ma1 distributed from the tracking device 2 at the point A as initial propagation, and activates a video analysis application program in the candidate detection unit 23 to start the monitoring (time t12).

The tracking device 2 at the point A continues the monitoring in accordance with the recognition model Mc1, but the suspect escapes to the point B (time t13).

The tracking device 2 at the point B finds the tracking target images of the persons Pb1 and Pb2 from the initially propagated recognition model Ma1 (time t21). The tracking device 2 at the point B then creates the recognition model Mb1 of the person Pb1 and the recognition model Mb2 of the person Pb2 by adding the feature quantities of the newly detected tracking target candidates while maintaining the feature quantities contained in the recognition model Ma1 before the update (time t22). The tracking device 2 at the point B redistributes the recognition models Mb1 and Mb2 updated thereby to points within a certain range around the point (points A and C in this case).

The tracking device 2 at the point C receives the recognition models Mb1 and MB2 distributed from the tracking device 2 at the point B, and activates the video analysis application program in the candidate detection unit 23 to start the monitoring. The tracking device 2 at the point A receives the recognition models Mb1 and Mb2 distributed from the tracking device 2 at the point B, replaces the recognition model Ma1 with the recognition models Mb1 and Mb2, and continues the monitoring. That is, when the destination to which the recognition models of the same target candidate (the same suspect) is distributed coincides with the source from which the distribution is performed (point A in this case), the old map at the distribution source is replaced with the new map.

At this point of time, the suspect escapes to the point C (time t23).

The tracking device 2 at the point C finds the person Pc1 from the recognition model Mb1 and finds the persons Pc2 and Pc3 from the recognition model Mb2 (time t31). The tracking device 2 at the point C then creates the recognition model Mc1 of the found person Pc1, the recognition model Mc2 of the found person Pc2, and the recognition model Mc3 of the found person Pc3 (time t32). The tracking device 2 at the point B receives the recognition models Mc1, Mc2, and Mc3 distributed from the tracking device 2 at the point C, replaces the recognition modes Mb1 and Mb2 with the recognition models Mc1, Mc2, and Mc3, and continues the monitoring.

The tracking device 2 at the point C continues the monitoring in accordance with the recognition models Mc1, Mc2, and Mc3 created at the time t32 (time t33).

FIG. 6 is a table showing processes subsequent to those in FIG. 5 after the observer specifies the suspect from the tracking target images.

At time t34 in FIG. 6, which follows the time t33 in FIG. 5, the tracking device 2 at the point A is performing the monitoring in accordance with the recognition models Mb1 and Mb2, the tracking device 2 at the point B is performing the monitoring in accordance with the recognition models Mc1, Mc2, and Mc3, and the tracking device 2 at the point C is performing the monitoring in accordance with the recognition models Mc1, Mc2, and Mc3.

At this point of time the observer visually checks the suspect candidate video images notified from the point C (person Pc1 associated with recognition model Mc1, person Pc2 associated with recognition model Mc2, and person Pc3 associated with recognition model Mc3), and inputs the correct choice trigger indicating that the person Pc1 associated with the recognition model Mc1 is determined as the suspect to the monitoring terminal 1 (time t41). Furthermore, the monitoring terminal 1 (or tracking device 2 at each point) refers to the distribution history associated with the recognition model Mc1 to identify the derived models of the person Pc1, the “recognition models Ma1, Mb1, and Mc1”.

FIG. 7 is a descriptive diagram showing the derived model of the person Pc1 for the SOM in FIG. 3. As indicated by a broken line 101, the recognition model Ma1 at the point A→the recognition model Mb1 at the point B→the recognition model Mc1 at the point C are distributed in this order, whereby the derived models “recognition models Ma1, Mb1, and Mc1” of the person Pc1 can be produced by following the distribution path described above in reverse. Narrowing down a future monitoring target to the derived models allows reduction in the monitoring burden on the observer.

The video images (tracking target images) notified (recommended) to the observer by the image reporting unit 21 at each point are video images corresponding to the derived models out of the tracking target candidates caught within a predetermined range from the point where the correct choice trigger is found within a predetermined period from the time when the correct choice trigger is found. The predetermined range is an area reachable from the correct choice trigger found point within a predetermined period from the correct choice trigger found time.

The monitoring terminal 1 therefore calculates (limit of suspect's moving speed)×(predetermined period)=(travel distance), and sets the area within the range (travel distance) around the correct choice trigger found point as the reachable area.

Returning to FIG. 6, the monitoring terminal 1 notifies the tracking device 2 at each of the points of the derived models of the person Pc1, the “recognition models Ma1, Mb1, and Mc1” (time t42).

Upon receipt of the notification of the derived models, the tracking device 2 at each of the points excludes the recognition models that do not correspond to the derived models (such as Mb2, Mc2, and Mc3) from the recognition model storage unit 25 to be monitored by the tracking device 2, and leaves the derived models (time t43). Persons different from the suspect can thus be excluded from the monitoring targets, whereby the monitoring load can be reduced. That is, it is possible to prevent an explosive increase in the number of models provided per tracking device 2 and stored in the recognition model storage unit 25 and the number of tracking target candidates.

Although FIG. 6 shows no corresponding example, when all the recognition models provided in the tracking device 2 and registered in the recognition model storage unit 25 are deleted as a result of the exclusion of maps that do not correspond to the derived models, the tracking device 2 can stop operating to reduce the monitoring load.

It is now assumed that the tracking device 2 at the point C finds the person Pc1, who is the suspect, by monitoring the recognition model Mc1 (time t51). At this point of time, the tracking device 2 at the point A clears the contents of the recognition model storage unit 25A (erasing all recognition models) and terminates the monitoring (time t52) because the point A is far from the point C where the suspect is found. On the other hand, the tracking device 2 at the point B is close to the point C, where the suspect is found, and therefore leaves the recognition model Mc1 in the recognition model storage unit 25B and continues to be alert to the suspect in the area around the point C.

The period required by the observer to check the video images for target identification can be shortened by excluding areas outside the range into which the suspect moves (predetermined range described above) from the monitoring target.

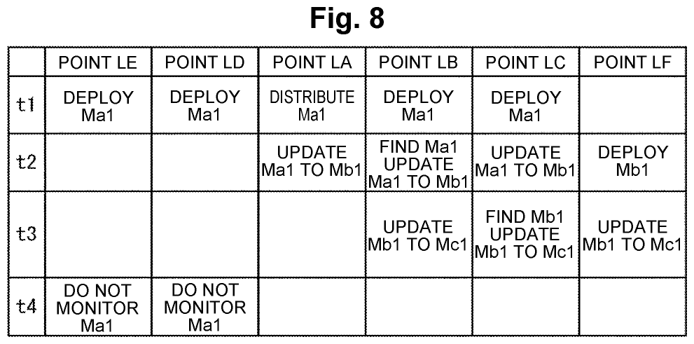

FIG. 8 is a table showing a labor saving process achieved by eliminating the monitoring performed by the moving target tracking system 100.

The description with reference to FIGS. 6 and 7 relates to the process of narrowing down a future monitoring target in response to the correct choice trigger issued by the observer. On the other hand, FIG. 8 relates to the process of narrowing down a future monitoring target in response to the frequency at which the recognition model storage unit 25 at each point is updated.

At the time t1, the model creation unit 24 at a point LA generates the same recognition model from video images of a target person continuously caught by the same camera in the same area (at point LA). That is, when the target person keeps staying in the same area, the process of creating a recognition model is also continued because feature quantities can be successively detected.

The recognition model Ma1 of a person found at the point LA is then initially propagated to (deployed at) points LB, LC, LD, and LE located in the vicinity of the point LA (within a radius of 5 km, for example). That is, when a new tracking target candidate is detected in the recognition model, the candidate detection unit 23 of the tracking device 2 responsible for analysis of video images from a camera within a certain distance from the camera having detected the new tracking target candidate is activated.

At the time t2, the recognition model Mb1 of the person found at the point LB based on the recognition model Ma1 is initially propagated to the points LA, LC, and LF located in the vicinity of the point LB. At the points LA and LC, which are distribution destinations, the recognition model Ma1 is updated to the recognition model Mb1, and at the point LF, which is a distribution destination, the recognition model Mb1 is initially propagated (deployed).

At the time t3, the recognition model Mc1 of the person found at the point LC based on the recognition model Mb1 is distributed to the points LB and LF located in the vicinity of the point LC. At the points LB and LF, which are distribution destinations, the recognition model Mb1 is updated to the recognition model Mc1.

The following description focuses on the points LD and LE. At the points LD and LE, the recognition model storage unit 25 associated with the tracking device 2 is not updated for a predetermined period (two turns in total, t=2 and t=3, for example) or longer after the recognition model Ma1 is deployed at the time t1. The points LD and LE where the recognition model is not updated for a while are therefore assumed to be areas where tracking target candidates are unlikely to be located. The tracking device 2 (candidate detection unit 23) at each of the points LD and LE may therefore perform no monitoring. As described above, as the tracking target candidate moves, the tracking device 2 (candidate detection unit 23) in which all recognition models are not updated for a certain period performs no monitoring.

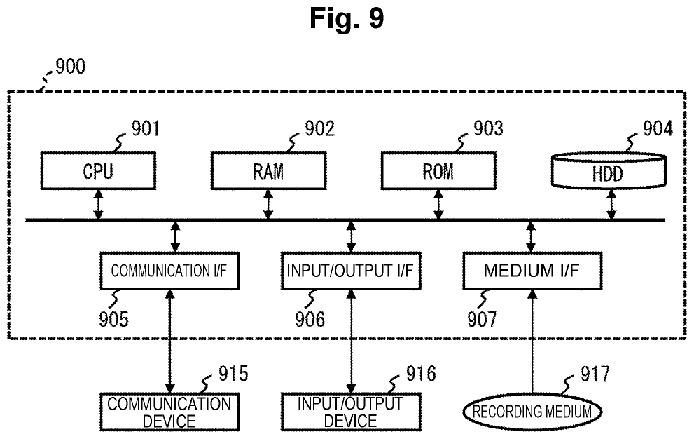

FIG. 9 shows the hardware configuration of each of the tracking devices 2.

The tracking device 2 is configured as a computer 900 including a CPU 901, a RAM 902, a ROM 903, an HDD 904, a communication I/F 905, an input/output I/F 906, and a medium I/F 907.

The communication I/F 905 is connected to an external communication device 915. The input/output I/F 906 is connected to an input/output device 916. The medium I/F 907 reads and writes data from and to a recording medium 917. Furthermore, the CPU 901 controls each processing unit by executing a program (also called application program or app that is abbreviation thereof) read into the RAM 902. The program can then be distributed via a communication line or recorded onto the recording medium 917 such as a CD-ROM and then distributed.

The aforementioned present embodiment has been described with reference to the process in which the tracking device 2 updates the recognition model storage unit 25 by adding a new feature quantity to an SOM map in the course of time-series variation in the feature quantity provided by input of video images from a monitoring camera into a CNN. Furthermore, the tracking device 2 can propagate the updated SOM map to another nearby point to properly track a running-away tracking target.

### Effects

The tracking device 2 according to the present invention includes

the recognition model storage unit 25, which stores a recognition model containing one or more feature quantities of a tracking target on a tracking target basis,

the candidate detection unit 23, which extracts the tracking target from images captured by a monitoring camera associated with the tracking device 2 by using the recognition model,

the model creation unit 24, which updates the recognition model in the recognition model storage unit 25 by adding a new feature quantity detected from the extracted tracking target to the recognition model used by the candidate detection unit 23 to extract the tracking target, and

the communication unit 26, which distributes the recognition model updated by the tracking device 2 to another device that performs the monitoring based on another monitoring camera located within a predetermined range from the monitoring camera associated with the tracking device 2.

Therefore, as the amount of feature quantity information on the tracking target increases, the corresponding recognition model is updated and successively distributed to other devices. As a result, even when a learned recognition model cannot be deployed at all points in advance, a recognition model of an initially detected target can be instantly created and utilized in video image analysis performed by a subsequent camera.

In the present invention, the recognition model storage unit 25 stores the recognition model updated by the tracking device 2 and a recognition model updated by the other device, and

when the recognition model distributed to the other device in the past is redistributed to the tracking device 2 after the recognition model is updated by the other device, the communication unit 26 deletes the recognition model distributed to the other device in the past from the recognition model storage unit 25.

Therefore, when the destination to which the recognition model is distributed of the same target candidate is the source from which the recognition model is distributed, the recognition model is replaced with the updated recognition model, whereby the number of recognition models held by each device can be reduced, and the speed of the analysis performed by the tracking device 2 can be increased.

In the present invention, the model creation unit 24 acquires the feature quantity of the tracking target from the video images captured by the monitoring camera based on a feature quantity vector containing the features of the images of the tracking target, and updates the recognition model in the recognition model storage unit 25 by placing the feature quantity of the tracking target in a data structure area mapped to a two-dimensional space while preserving the topological structure of the data distribution with respect to an observed data set, and

the candidate detection unit 23 extracts the tracking target when the feature quantity of the tracking target contained in the images captured by the monitoring camera is similar to the feature quantity of the tracking target registered in the data structure area.

The feature quantity of the tracking target can thus be automatically extracted from the feature quantity vector with no need for in-advance definition of the feature quantity.

In the present invention, the model creation unit 24 generates the same recognition model from a tracking target continuously caught from video images captured by the same camera in the same area, and

when the recognition model in the recognition model storage unit 25 is not updated for a predetermined period, the candidate detection unit 23 does not carry out the process of extracting the tracking target.

The resource consumed by the tracking device 2 can thus be reduced by not carrying out the tracking process in an area where the tracking target is unlikely to exist.

The present invention relates to a tracking system including the tracking devices 2 and the monitoring terminal 1 operated by an observer,

the tracking devices each further includes the image reporting unit 21, which transmits to the monitoring terminal 1 a captured image containing the tracking target extracted by the candidate detection unit 23,

the monitoring terminal 1 receives an input that specifies a correct choice tracking target from the transmitted captured images, and sends the correct choice tracking target back to the tracking device, and

the model creation unit 24 of each of the tracking devices deletes feature quantities of tracking targets other than the correct choice tracking target and feature quantities of tracking targets outside a travel limit range of the correct choice tracking target from the recognition model in a storage unit associated with the model creation unit 24, and allows tracking devices having no tracking target in the recognition model as a result of the deletion not to carry out the process of extracting a tracking target.

The number of tracking targets to be proposed to the monitoring terminal 1 can thus be suppressed by appropriately excluding incorrect choice tracking targets.

### REFERENCE SIGNS LIST

1 Monitoring terminal

2 Tracking device

21 Image reporting unit

22 Image file storage unit

23 Candidate detection unit

24 Model creation unit

25 Recognition model storage unit

26 Communication unit

100 Moving target tracking system (tracking system)

1. A tracking device comprising:
a recognition model storage configured to store a recognition model including one or more feature quantities of a tracking target on a tracking target basis;
a candidate detection unit, implemented using one or more computing devices, configured to extract the tracking target from images captured by a monitoring camera associated with the tracking device by using the recognition model;
a model creation unit, implemented using one or more computing devices, configured to update the recognition model in the recognition model storage by adding a new feature quantity detected from the extracted tracking target to the recognition model used by the candidate detection unit to extract the tracking target; and
a communication unit, implemented using one or more computing devices, configured to distribute the recognition model updated by the tracking device to another device that performs monitoring based on another monitoring camera located within a predetermined range from the monitoring camera associated with the tracking device.

2. The tracking device according to claim 1,
wherein the recognition model storage is configured to store the recognition model updated by the tracking device and a recognition model updated by the other device, and
based on the recognition model distributed to the other device in the past being redistributed to the tracking device after the recognition model is updated by the other device, the communication unit is configured to delete the recognition model distributed to the other device in the past from the recognition model storage.

3. The tracking device according to claim 1,
wherein the model creation unit is configured to:
acquire the feature quantity of the tracking target from the images captured by the monitoring camera based on a feature quantity vector including features of the images of the tracking target, and
update the recognition model in the recognition model storage by placing the feature quantity of the tracking target in a data structure area mapped to a two-dimensional space while preserving a topological structure of a data distribution with respect to an observed data set, and
wherein the candidate detection unit is configured to, based on the feature quantity of the tracking target included in the images captured by the monitoring camera being identical to the feature quantity of the tracking target registered in the data structure area, extract the tracking target.

4. The tracking device according to claim 1,
wherein the model creation unit is configured to generate the same recognition model from a tracking target continuously detected from video images captured by the same camera in the same area, and
the candidate detection unit is configured to, based on the recognition model in the recognition model storage not being updated for a predetermined period, omit a process of extracting the tracking target.

5. The tracking device according to claim 1, wherein:
the tracking device is provided in plurality and implemented in a tracking system, the tracking system including a monitoring terminal operated by an observer,
each of the plurality of tracking devices further includes an image reporting unit, implemented using one or more computing devices, configured to transmit, to the monitoring terminal, a captured image including the tracking target extracted by the candidate detection unit,
the monitoring terminal receives an input that specifies a correct choice tracking target from the transmitted captured image, and sends the correct choice tracking target back to the tracking device, and
the model creation unit of each of the plurality of tracking devices deletes feature quantities of tracking targets other than the correct choice tracking target and feature quantities of tracking targets outside a travel limit range of the correct choice tracking target from the recognition model in a storage associated with the tracking device, and allows one or more tracking devices having no tracking target in the recognition model as a result of the deletion to omit a process of extracting a tracking target.

6. A tracking method comprising:
storing, at a recognition model storage, a recognition model including one or more feature quantities of a tracking target on a tracking target basis,
extracting the tracking target from images captured by a monitoring camera associated with a tracking device by using the recognition model,
updating the recognition model in the recognition model storage by adding a new feature quantity detected from the extracted tracking target to the recognition model used for extracting the tracking target, and
distributing the updated recognition model to another device that performs monitoring based on another monitoring camera located within a predetermined range from the monitoring camera associated with the tracking device.

7. A non-transitory computer recording medium storing a tracking program, wherein execution of the tracking program causes one or more computers to perform operations comprising:
storing, at a ]recognition model storage, a recognition model including one or more feature quantities of a tracking target on a tracking target basis,
extracting the tracking target from images captured by a monitoring camera associated with a tracking device by using the recognition model,
updating the recognition model in the recognition model storage by adding a new feature quantity detected from the extracted tracking target to the recognition model used for extracting the tracking target, and
distributing the updated recognition model to another device that performs monitoring based on another monitoring camera located within a predetermined range from the monitoring camera associated with the tracking device.

8. The non-transitory computer recording medium according to claim 7, wherein the operations further comprise:
storing the recognition model updated by the tracking device and a recognition model updated by the other device, and
based on the recognition model distributed to the other device in the past being redistributed to the tracking device after the recognition model is updated by the other device, deleting the recognition model distributed to the other device in the past from the recognition model storage.

9. The non-transitory computer recording medium according to claim 7, wherein the operations further comprise:
acquiring the feature quantity of the tracking target from the video images captured by the monitoring camera based on a feature quantity vector including features of the images of the tracking target, and
updating the recognition model in the recognition model storage by placing the feature quantity of the tracking target in a data structure area mapped to a two-dimensional space while preserving a topological structure of a data distribution with respect to an observed data set, and
based on the feature quantity of the tracking target included in the images captured by the monitoring camera being identical to the feature quantity of the tracking target registered in the data structure area, extracting the tracking target.
